(19) United States
(12) Patent Application Publication
(10) Pub. No.: US 2006/0096639 A1
(43) Pub. Date: May 11, 2006

(54) Condensate drain tray connector

(76) Inventor: Gregory Coogle, Pembroke Pines, FL (US)

Correspondence Address: YI LI, CUSPA TECHNOLOGY LAW ASSOCIATES, 11820 SW 107 AVENUE, MIAMI, FL, 33176, US

(21) Appl. No.: 11/116,975

(22) Filed: Apr. 28, 2005

Related U.S. Application Data
(63) Continuation-in-part of application No. 10/990,685, filed on Nov. 16, 2004.
Application No. 10/990,685 is a continuation-in-part of application No. 10/982,573, filed on Nov. 5, 2004.

(51) Int. Cl. G05D 9/00

(52) U.S. Cl. 137/268

(57) ABSTRACT

A condensate drain tray connector includes a connector body including an elongated hollow tube having an open upper end and an opposing open lower end, and an inlet tubular connector connected perpendicularly to the hollow tube; a top cap removably connected to the upper end of the hollow tube; and a liquid level senor removably connected to the connector body. The liquid level senor includes a sensing portion disposed within the connector body and an external linkage portion extending outside of the connector body. The connector body further includes a cleaning spout opposing the inlet tubular connector for cleaning, and a basket disposed within the hollow tube for dispending chemicals. The connector body can also include a water trap portion which integrally extends from the lower end of the hollow tube.

### CROSS-REFERENCE TO RELATED APPLICATION

This application is a continuation-in-part of patent application Ser. No. 10/990,685, filed on Nov. 16, 2004, which is a continuation-in-part of patent application Ser. No. 10/982,573, filed Nov. 5, 2004. All parent applications are incorporated herein by reference in their entirety.

### FIELD OF THE INVENTION

The present invention relates to a condensate drain tray connector for connecting the condensate drain tray of an air conditioner to the downstream drainage pipe, which comprises a removable liquid level sensor for detecting drainage pipe clogging, and means for dispensing chemicals into the drainage pipe to inhibit microbial growth.

### BACKGROUND OF THE INVENTION

The condensation of water in air conditioning equipments requires constant collection and disposal of water through condensate drainage pipes. The water standing still encourages the growth of microbials, such as algae, bacteria and other organisms that gradually clog the pipes. A few designs for delivering chemicals into condensate drainage pipe have been designed in the past. However, many of them either are too complex, or not adequate for solving the problems. Commercially, growth inhibiting chemical tablets are available to be placed directly into the condensate drain tray, also referred to as drain pan, to control microbial growth. However, the chemical tablets can cause corrosion of the tray and reduce lifetime of the condensate drain tray.

Once the condensate drainage pipe is clogged, the condensate water backs up to the condensate drain tray in the air handler, which can cause substantial damage of the air conditioning system. Detection devices have been developed to detect the water level increase in the condensate drain tray and to trigger a control system to shut down the air conditioner when the clogging occurs. U.S. Pat. No. 5,522,229 teaches a blockage detector which includes a drain tube and a liquid sensor probe located at least partially in the drain tube, wherein the liquid sensor probe has a probe end extending from the drain tube inlet end into the drain pan, when the drain tube is connected to the drain pan. This type of detector detects the clogging of the downstream drainage pipe until the water is already backed up to the drain pan. At this point, potential damages to the air conditioning system can already occur because of water overflow.

Furthermore, the clogging detection devices known in the art are permanently attached to the drainage pipes or connectors. When the detection device fails, one has to cut the pipe to remove or replace the device from the drainage system.

Therefore, it is desirable to have a clogging detection device which enables an early detection of clogging, particularly prior to the condensate water backing up to the condensate drain tray. It is also desirable to have a removable detection device which can be conveniently removed from the drainage system for maintenance or replacement.

It is further desirable to have a chemical delivery system suitable for dispensing growth control chemicals, at the very beginning of the drainage pipe to effectively control microbial growth in the downstream drainage pipe, but avoid a direct contact of chemicals with the condensate drain tray.

### SUMMARY OF THE INVENTION

In one embodiment, the present invention is directed to a condensate drain tray connector, which comprises (a) a connector body comprising an elongated hollow tube having an open upper end and an opposing open lower end for connecting to a downstream condensate drainage pipe; an inlet tubular connector having a first end connected perpendicularly to the hollow tube and being in fluid communication with the hollow tube, and an opposing second end for connecting to a condensate drain tray; and a cleaning spout including one end connected perpendicularly to the hollow tube and disposed opposing the inlet tubular connector, and an opposing spout opening covered by a removable spout cap; (b) a basket removably disposed within the hollow tube of the connector body for receiving a growth inhibiting chemical; and (c) a top cap removably connected to the open upper end of the hollow tube of the connector body. The basket can further include a pair of access openings positioned opposite each other, and the access openings are aligned with the inlet tubular connector and the spout opening of the connector body.

In a further embodiment, the present invention is directed a condensate drain tray connector, which comprises (a) a connector body comprising an elongated hollow tube having an open upper end and an opposing open lower end for connecting to a downstream condensate drainage pipe; and an inlet tubular connector connected perpendicularly to the hollow tube, and being in fluid communication with the hollow tube; (b) a top cap comprising a top cover portion, and a fastening portion extending downwardly from the top cover portion, the top cap being removably connected to the open upper end of the hollow tube of the connector body; and (c) a liquid level senor including a sensing portion disposed within the connector body and an external linkage portion extending outside of the connector body; and the liquid level senor being removably connected to the connector body.

In one configuration, the inlet tubular connector has a receiving opening on an upper side of the inlet tubular connector between a first end and a second end of the inlet tubular connector, and the receiving opening has an internal thread. The liquid level sensor includes an adaptor portion connected between the sensing portion and the external linkage portion. The adaptor portion has an external thread complementary to the internal thread of the receiving opening of the inlet tubular connector. The liquid level sensor is removably thread-connected to the receiving opening of the inlet tubular connector; wherein the sensing portion of the liquid level sensor is disposed inside the inlet tubular connector between the first and second ends of the inlet tubular connector.

In another configuration, the liquid level sensor is attached to the top cover portion of the top cap. The sensing portion of the liquid level senor includes a sensor head and an extender portion that connects the sensor head to the top cap; and the sensing portion extends downwardly from the top cap and is disposed inside the hollow tube of the connector body. Preferably, the sensor head is disposed below the inlet tubular connector for early detection of clogging of the downstream drainage pipe.

In yet a further embodiment, the present invention is directed to a removable liquid level sensor cap assembly, which comprises (a) a cap comprising a circular top cover portion; and a fastening portion extending downwardly from the top cover portion; the fastening portion having connection means in an interior thereof for connecting to a tubular conduit; and (b) a liquid level sensor attached to the top cover portion of the cap. The liquid level sensor comprises a sensing portion extending downwardly from the top cover portion, and an external linkage portion extending outwardly from the top cover portion. The sensing portion of the liquid level senor includes a sensor head and an extender portion connecting the sensor head to the top cover portion of the removable liquid level sensor cap; and the sensor head is connected electronically to the external linkage portion through the extender portion. The external linkage portion connects the removable liquid level sensor cap to a control system.

In another embodiment, the present invention is directed to a condensate drain tray connector, which comprises (a) a connector body comprising an elongated hollow tube portion having an open upper end, and an opposing lower end integrally connected to a water trap portion, with one side of the lower end extending into an external wall of the water trap portion, and with an opposing side of the lower end forming an internal divider within the water trap portion; the water trap portion including an outlet tubular connector for connecting to a downstream condensate drainage pipe, the outlet tubular connector being perpendicularly to the hollow tube portion and being disposed on the same side of the internal divider; and an inlet tubular connector connected perpendicularly to the hollow tube portion on an opposing side of the outlet tubular connector, and being in fluid communication with the hollow tube; and (b) a top cap removably connected to the open upper end of the hollow tube of the connector body. The water trap portion further comprises a bottom opening at a bottom of the water trap portion, and a bottom cap removably connected to the bottom opening. The connector body further comprises a cleaning spout, and a basket disposed within the hollow tube portion for receiving a growth inhibiting chemical. The top cap can further comprises the liquid level sensor as described above.

### BRIEF DESCRIPTION OF THE DRAWINGS

FIG. 1 is a perspective view of a condensate drain tray connector of one embodiment of the present invention.

FIG. 2 is a partial cutaway view of the condensate drain tray connector of FIG. 1.

FIG. 3 is an exploded partial cutaway view of the condensate drain tray connector of FIG. 1.

FIG. 4 is a partial cutaway view of the condensate drain tray connector of FIG. 1, wherein the basket further includes a pair of access openings.

FIG. 5 is a perspective view of the basket of the condensate drain tray connector shown in FIG. 4.

FIG. 6 is a partial cutaway view of the condensate drain tray connector shown in FIG. 4, with the top cap removed.

FIG. 7 is a partial cutaway view of the condensate drain tray connector of a further embodiment of the present invention.

FIG. 8 is a partial cutaway view of the top cap of the condensate drain tray connector of FIG. 7.

FIG. 9 is a partial cutaway view of the condensate drain tray connector shown in FIG. 7, which further includes a basket.

FIG. 10 is a partial cutaway view of the condensate drain tray connector of another embodiment of the present invention.

FIG. 11 is an exploded partial cutaway view of the condensate drain tray connector of the embodiment shown in FIG. 10.

FIG. 12 is a partial cutaway view of the condensate drain tray connector that includes a water trap portion in a further embodiment of the present invention.

### DETAILED DESCRIPTION OF THE INVENTION

The present invention provides a condensate drain tray connector for connecting between the condensate drain tray of an air conditioner and a downstream drainage pipe.

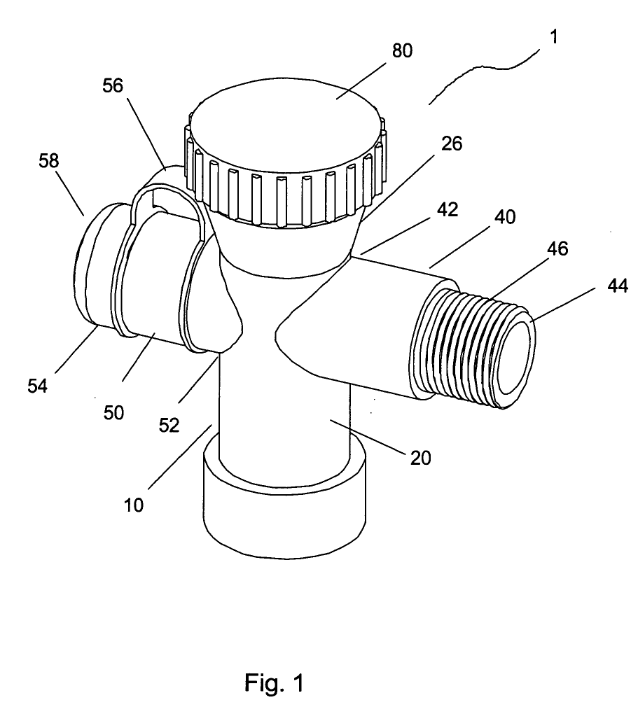

In one embodiment, as shown in FIGS. 1 to 6, the condensate drain tray connector 1 comprises a connector body 10, a basket 60 and a top cap 80.

As shown in FIGS. 1 to 3, connector body 10 comprises an elongated hollow tube 20, an inlet tubular connector 40 and a cleaning spout 50.

Hollow tube 20 has an open upper end 22 and an opposing open lower end 24 for connecting to a downstream condensate drainage pipe (not shown). Inlet tubular connector 40 has a first end 42 that is connected perpendicularly to hollow tube 20 and is in fluid communication with hollow tube 20, and an opposing second open end 44. Inlet tubular connector 40 has connection means 46 at second open end 44 for connecting to a condensate drain tray (not shown). Cleaning spout 50 includes one end 52 that is connected perpendicularly to hollow tube 20 and disposed opposing inlet tubular connector 40, and an opposing spout opening 54 covered by a removable spout cap 58. Cleaning spout 50 is in fluid communication with hollow tube 20. Optionally, removable spout cap 58 is further attached to cleaning spout 50 by attachment means 56, which retains spout cap 58 attached to connector body 10 when spout cap 58 is removed from spout opening 54 during cleaning.

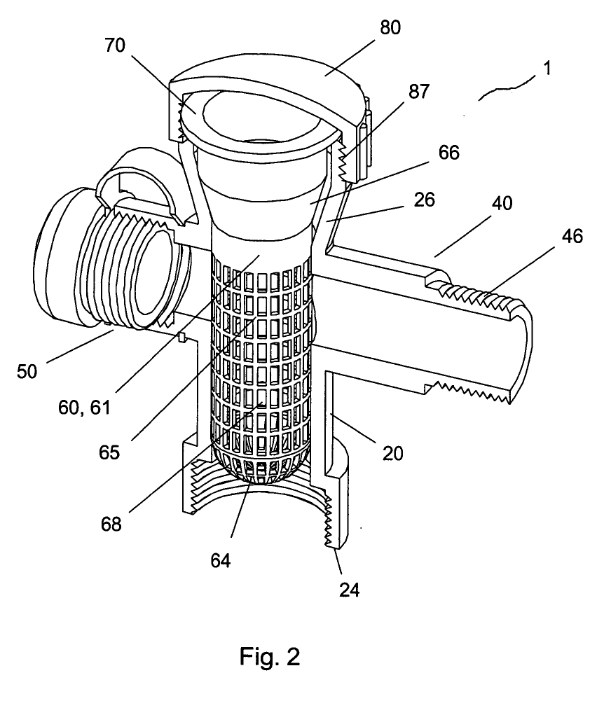

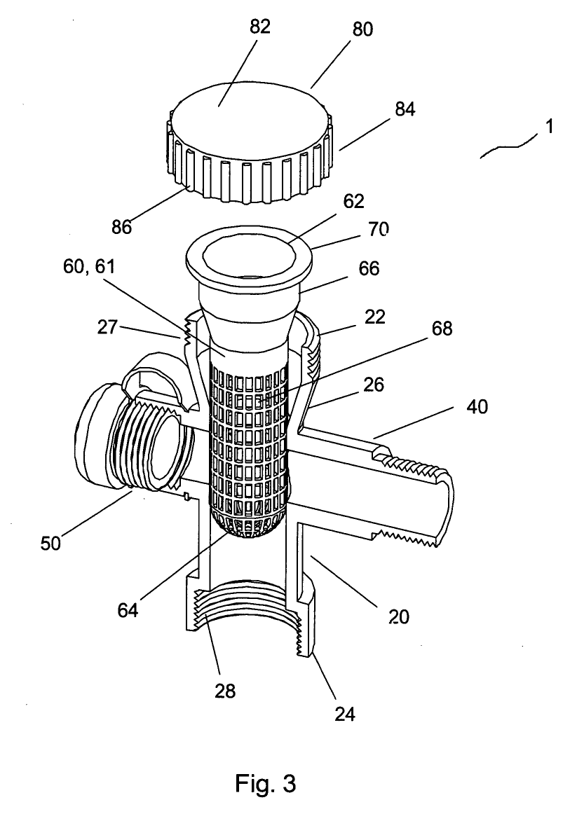

In a preferred embodiment as shown in FIGS. 2 and 3, hollow tube 20 has an enlarged upper portion 26 to form a funnel shape at open upper end 22. The funnel shape structure facilitates addition of a liquid chemical, such as chlorine, into the downstream drainage pipe through hollow tube 20. Furthermore, hollow tube 20 has connection means adjacent to open upper and lower ends 22, 24 for connection with top cap 80 and the downstream drainage pipe. In the embodiment shown in FIGS. 2 and 3, hollow tube 20 has an external thread 27 adjacent to open upper end 22, and an internal thread 28 adjacent to open lower end 24 for thread connections with top cap 80 and the downstream drainage pipe. It should be understood that other suitable connection means providing a fluid tight connection between the hollow tube and cap, and between hollow tube and the drainage pipe can also be used for the purpose of the present invention. For example, open lower end 24 can have an internal enlarged tubular section as a female receiver to the downstream condensate drainage pipe. The downstream condensate drainage pipe can be inserted into, and sealed by a glue to, open lower end 24.

Top cap 80 includes a top cover portion 82, and a fastening portion 84 integrally extending downwardly from top cover portion 82. Fastening portion 84 has an internal thread 87 that is complementary to external thread 27 adjacent to open upper end 22 of hollow tube 20. Top cap 80 is removably connected to open upper end 22 of hollow tube 20 and it is removed when depositing growth inhibiting chemicals through open upper end 22, and when cleaning.

Preferably, there is gripping assistant means on the external periphery of fastening portion 84 of top cap 80 to help the user to grip the cap. As shown in FIG. 3, gripping assistant means are a plurality of protruding ridges 86 along the external periphery of the cap. Alternatively, the gripping assistant means can also be a plurality of grooves, or other suitable means.

Basket 60 is removably disposed within hollow tube 20 of connector body 10 for receiving a growth inhibiting chemical. Basket 60 has an elongated basket body 61 which has an open upper end 62, a closed lower end 64, and a plurality of apertures 68 disposed around middle portion 65 and lower end 64. Basket 60 has a height similar to the height of hollow tube 20. Basket 60 also has retainer means 70 for attaching basket 60 to upper end 22 of hollow tube 20. In the embodiment shown in FIGS. 2 and 3, retainer means 70 is a periphery flange around open upper end 62. When basket 60 is disposed into hollow tube 20, periphery flange 70 sits on top of open upper end 22 of hollow tube 20, which hangs basket 60 to the top of hollow tube 20.

Preferably, basket 60 has an enlarged upper portion 66 to form a funnel shape at open upper end 62 as shown in FIGS. 2 and 3. Furthermore, the outer diameter of elongated basket body 61 can be complementary to the inner diameter of elongated hollow tube 20, to provide a tight surface contact. The tight surface contact can lead the debris from the condensate drain tray falling into basket 60 through apertures 68, which can be easily cleaned by decanting the basket.

When basket 60 is used, chemical tablets can be placed into the basket, wherein the tablets dissolve slowly and release into the downstream drainage pipe with the condensate water, which controls the growth of microbials, particularly algae, in the downstream condensate drainage pipe. Suitable growth inhibiting chemicals include tablets containing antimicrobials, such as Frost King Pan-Tablets manufactured by Thermwell Products, Co., Inc., New Jersey. A liquid antimicrobial can also be added into the downstream condensate drainage pipe through hollow tube 20.

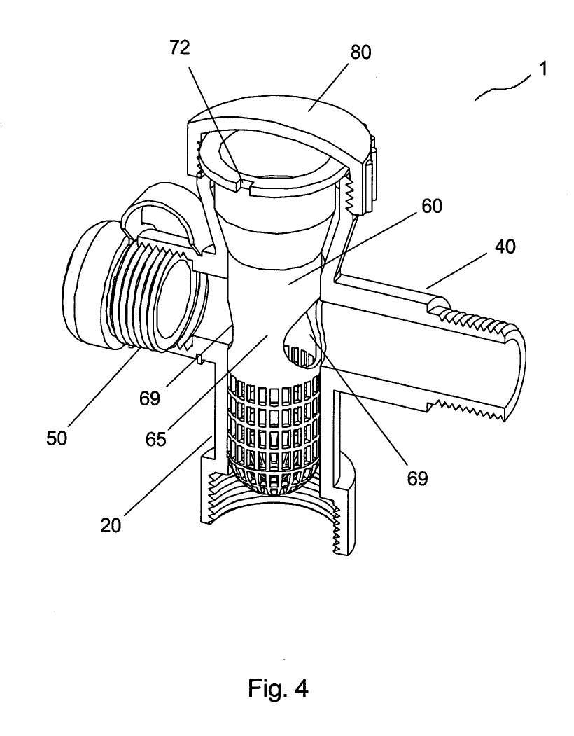

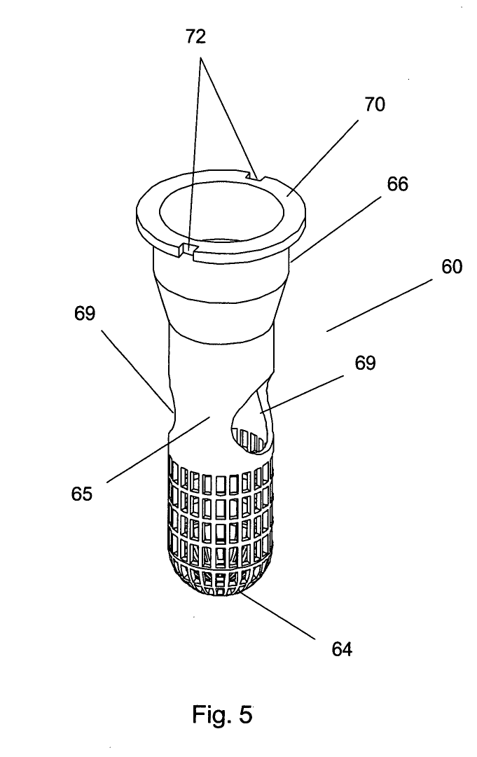

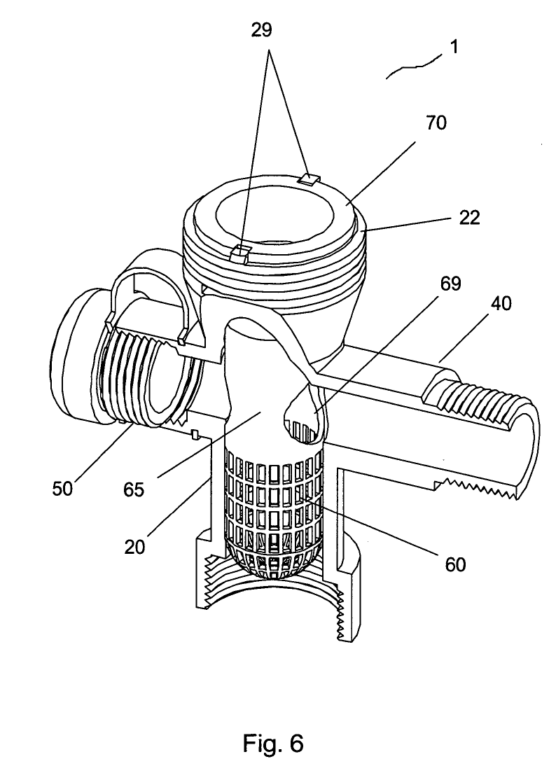

Furthermore, basket 60 can also have a pair of access openings 69 at middle portion 65, as shown in FIGS. 4 to 6. Access openings 69 are disposed opposing each other, and they are vertically and horizontally aligned with inlet tubular connector 40 and cleaning spout 50 when basket 60 is disposed into hollow tube 20. As shown, in the presence of access openings 69, one can reach inlet tubular connector 40 from cleaning spout 50 without taking out basket 60. To maintain the alignment, preferably, basket 60 and upper end 22 of hollow tube 20 further comprise alignment means. As shown in FIGS. 5 and 6, basket 60 has a pair of notches 72 on periphery flange 70 and hollow tube 20 has a pair of ridges 29 complementary to notches 72, for aligning access openings 69 with inlet tubular connector 40 and cleaning spout 50. It is noted that in this configuration, the middle portion 65 may not need apertures, since the debris from inlet tubular connector 40 can fall in the basket through access openings 69.

For cleaning the interior of the pipes, typically a flexible brush is used. The flexible brush includes a brush head and a long flexible handle. The flexible brush can be inserted through cleaning spout 50 through access openings 69 into inlet tubular connector 40 to clean any build-up or debris from the condensate drain tray. The build-up or debris can be collected into basket 60 during cleaning and discard after cleaning, which can reduce the chance of clogging in the downstream drainage pipe.

In a further embodiment, the present invention provides a condensate drain tray connector that has a removable liquid level sensor.

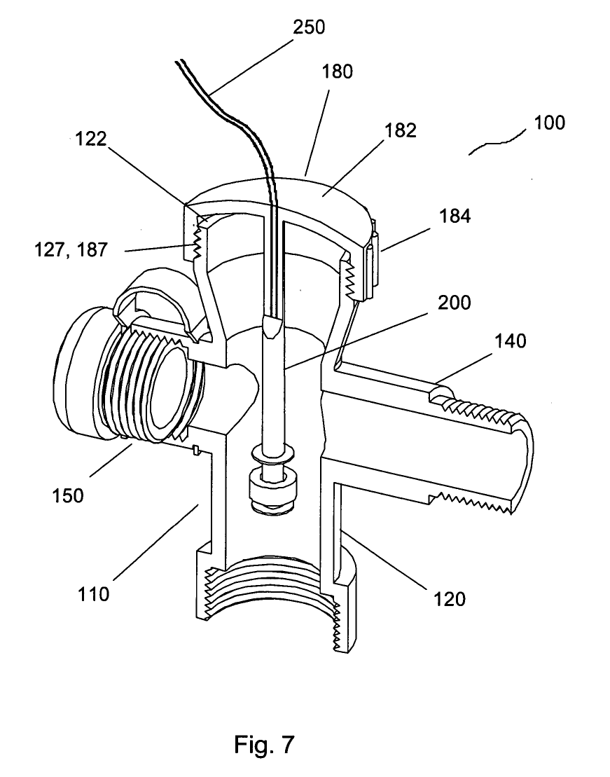

In one embodiment, as shown in FIGS. 7 to 9, condensate drain tray connector 100 comprises a connector body 110 and a top cap 180. Connector body 110 has the same structure of connector body 10, and it comprises elongated hollow tube 120, inlet tubular connector 140 and cleaning spout 150, wherein the structures of these components are the same as the corresponding components of connector body 10.

Top cap 180 includes a top cover portion 182, and a fastening portion 184 integrally extending downwardly from top cover portion 182. Fastening portion 184 has an internal thread 187 that is complementary to external thread 127 of hollow tube 120. Top cap 180 is removably connected to open upper end 122 of hollow tube 120.

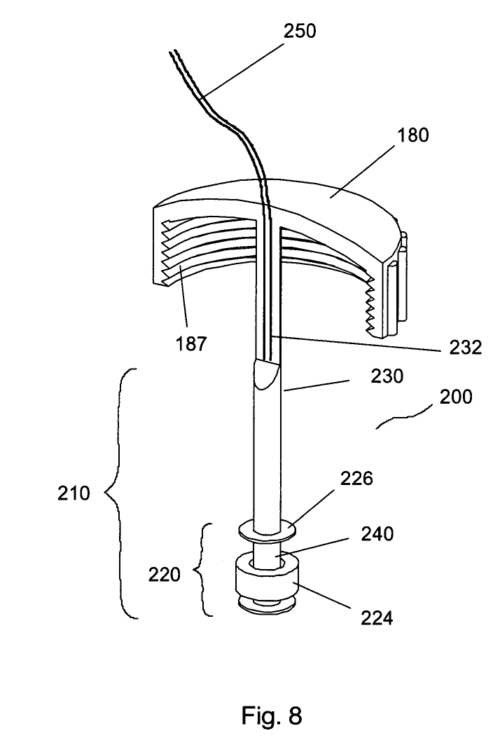

As shown in FIGS. 7 and 8, top cap 180 has a liquid level sensor 200 attached to top cover portion 182 for sensing water level increase caused by clogging of the downstream condensate drainage pipe. Liquid level sensor 200 has a sensing portion 210 extending downwardly from top cover portion 182 of top cap 180, being disposed within hollow tube 120, and an external linkage portion 250 extending upwardly from top cover portion 180. Sensing portion 210 includes a sensing head 220 and an extender portion 230. Extender portion 230 contains therein an internal linkage portion 232, which is integrally connected to external linkage portion 250. Internal linkage portion and external linkage portion are typically electrical wires connecting liquid level sensor 200 to a control system.

In the embodiment shown in FIGS. 7 to 9, liquid level sensor 200 is a float sensor, wherein sensing head 220 includes a circular float 224 attached to the bottom of a stem 240, and a stop 226 disposed above float 224. When the water level increases due to clogging of the downstream condensate drainage pipe, float 224 lifts up along stem 240, causing the engagement of two magnets embedded in float 224 and stem 240, respectively, which closes an electrical circuit, and hence, triggers the control system to shut down the air conditioner. In the embodiment shown, stem 240 can be integrally connected to extender portion 230. It is noted that in addition to the float sensor, other suitable liquid level sensors can also be used for the purpose of the present invention.

In a preferred embodiment, extender portion 230 has a sufficient length such that sensing head 220 is disposed below inlet tubular connector 140. Positioning sensing head 220 below inlet tubular connector 140 enables early detection of clogging of the downstream condensate drainage pipe, prior to the water level arising to the level of the condensate drain tray. Therefore, the condensate drain tray connector 110 of the present invention provides a mechanism of early detection of clogging, and prevents potential damage of the air conditioning system.

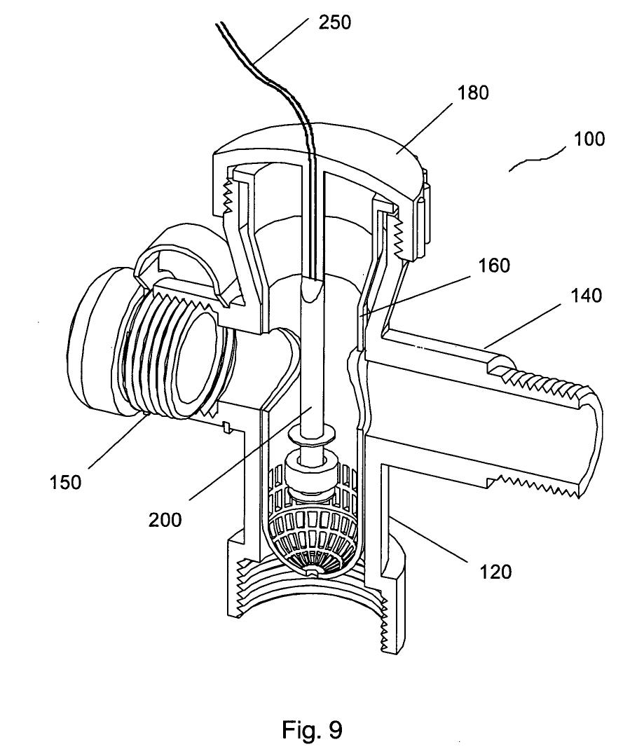

As shown in FIG. 9, optionally condensate drain tray connector 100 can further include a basket 160 disposed within hollow tube 120. The structure and function of basket 160 are the same as those of basket 60 described above. As shown, in the presence of basket 160, sensing portion 210 of liquid level sensor 200 is disposed within basket 160.

Since liquid level sensor 200 is attached to top cap 180, it can be easily removed from condensate drain tray connector 100 by detaching top cap 180. For a float sensor, it is common that debris or build-up can restrict the movement of float 224, and affect performance of the sensor. Using condensate drain tray connector 100 of the present invention, the liquid level sensor can be easily cleaned to maintain its function. Furthermore, if the liquid level sensor needs to be replaced, one can simply replace liquid level sensor 200 together with top cap 180 with a new top cap and liquid level sensor assembly.

Therefore, as a further embodiment, the present invention is directed to a removable liquid level sensor cap assembly that comprises a top cap and a liquid level sensor, as described above and shown in FIG. 8. It should be understood that the removable liquid level sensor cap assembly is described above as a component of condensate drain tray connector 100, however, it can be used independent of the condensate drain tray connector, and can be attached to various tubular conduits for monitoring liquid level within the conduits as needed. It is noted that the length of extender portion 230 can be made to meet specific requirement of a particular conduit.

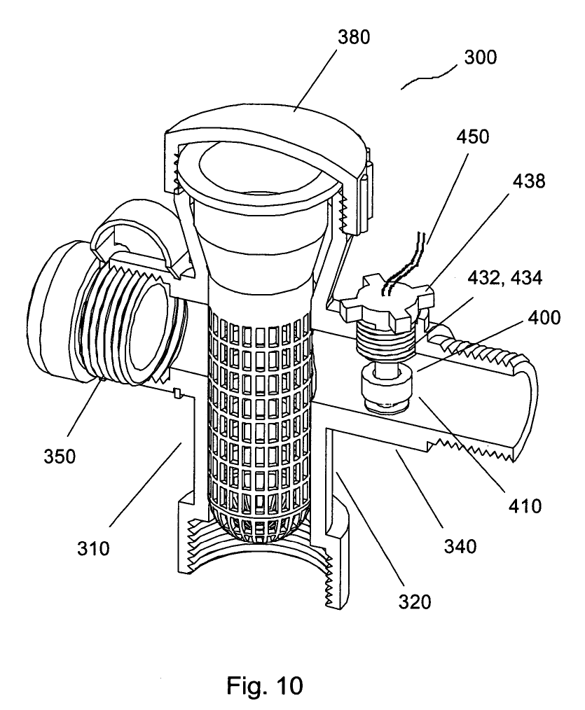

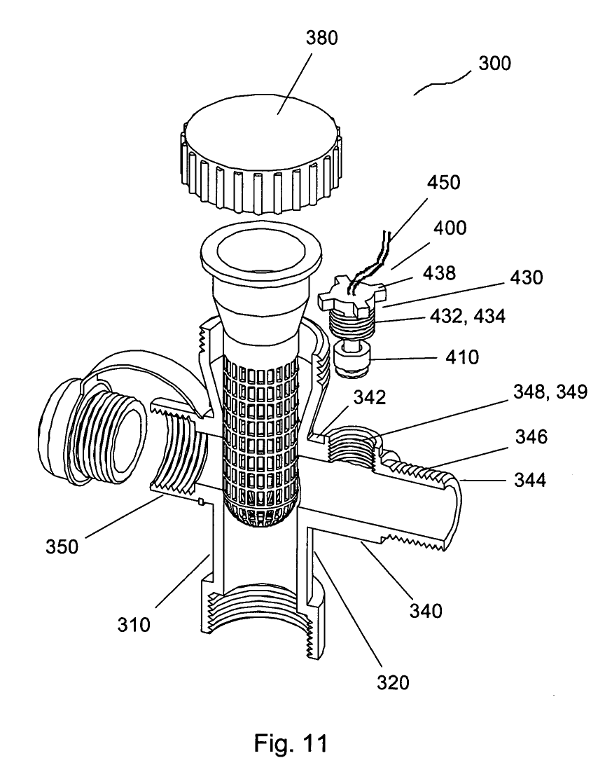

In another embodiment, as shown in FIGS. 10 and 11, the present invention provides a condensate drain tray connector 300, which has a different arrangement for the removable liquid level sensor. Condensate drain tray connector 300 comprises a connector body 310, a top cap 380 and a removable liquid level sensor 400. Connector body 310 has a similar structure of connector body 10, and it comprises elongated hollow tube 320, inlet tubular connector 340 and cleaning spout 350. The structures of hollow tube 320 and cleaning spout 350 are the same as the corresponding components of connector body 10.

Inlet tubular connector 340 has a first end 342 that is connected perpendicularly to hollow tube 320 and is in fluid communication with hollow tube 320, and an opposing second open end 344. Inlet tubular connector 340 has connection means 346 at second open end 344 for connecting to a condensate drain tray (not shown). As shown in FIGS. 10 and 11, inlet tubular connector 340 further includes a receiving opening 348 at the upper portion of inlet tubular connector 340, between first end 342 and second end 344. Receiving opening 348 has an internal thread 349 for thread-connection to liquid level sensor 400.

As shown, liquid level sensor 400 has a sensing portion 410, an adaptor portion 430, and an external linkage portion 450 connecting liquid level sensor 400 to a control system. In the embodiment shown, sensing portion 410 is a float sensor, as described above in liquid level sensor 200.

Adaptor portion 430 has a cylindrical portion 432 which has an external thread 434 complementary to internal thread 349 of receiving opening 348 of inlet tubular connector 340, and a handle portion 438. Adaptor portion 430 also includes therein an internal linkage portion (not shown) which is integrally connected to external linkage portion 450. Liquid level sensor 400 is thread-connected to receiving opening 348 of inlet tubular connector 340, with sensing portion 410 disposed within inlet tubular connector 340 between first end 342 and second end 344, and with handle portion 438 outside inlet tubular connector 340. Using handle portion 438, one can conveniently install liquid level sensor 400 into, or remove from, condensate drain tray connector 300 through the thread connection. Therefore, sensing portion 410 can be easily cleaned, and when needed, liquid level sensor 400 can be conveniently replaced.

It is apparent that using the condensate drain tray connector 300 of the present invention it not only extends the life time of the liquid level sensor because of a feasible maintenance, it also reduces the cost of replacing the sensor, in comparison to the replacement of the entire condensate drain tray connector when the sensor is permanently attached to the connector.

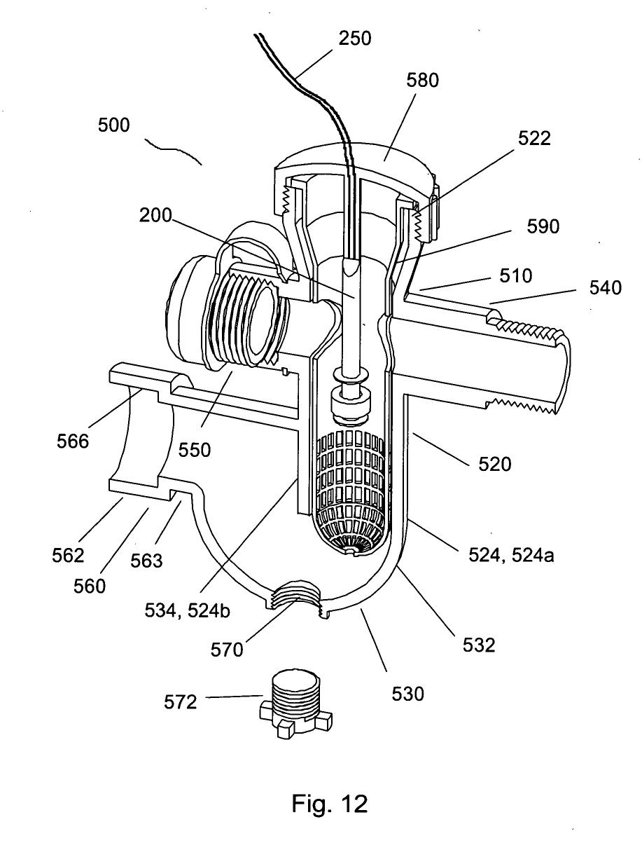

In another embodiment, the present invention provides a condensate drain tray connector that includes a water trap. As shown in FIG. 12, condensate drain tray connector 500 comprises a connector body 510 and a top cap 580. It is noted that top cap 580 can have the same structures of top cap 80 or top cap 180 as described previously in condensate drain tray connectors 1 and 100, respectively. More specifically, in one embodiment, top cap 580 is the same as top cap 80, which is used to cover connector body 510. In a preferred embodiment, top cap 580 is the same as top cap 180 that includes liquid level sensor 200, which is described in detail hereinbefore.

As shown, connector body 510 has an elongated hollow tube portion 520 that has an open upper end 522, and an opposing lower end 524 that is integrally connected to a water trap portion 530. One side 524a of low end 524 extends into an external wall 532 of water trap portion 530, and an opposing side 524b of low end 524 forms an internal divider 534 within water trap portion 530. Water trap portion 530 includes an outlet tubular connector 560 for connecting to a downstream condensate drainage pipe (not shown). Outlet tubular connector 560 is perpendicularly to hollow tube portion 520 and is disposed on the same side of internal divider 534. The lower side 563 of outlet tubular connector 560 is higher than the bottom edge of internal divider 534 such that internal divider 534 and the condensate water accumulated in water trap portion 530 form a barrier between the condensate drain tray and downstream drainage pipe.

Outlet tubular connector 560 has connection means 566 at open end 562 for engaging with the downstream drainage pipe, or engaging with a swivel which is in turn connected to the drainage pipe. Connection means 566 can be a smooth female interface portion (as shown), an internal thread, or other suitable means. Inlet tubular connector 540 is connected perpendicularly to hollow tube portion 520, and on the opposing side of outlet tubular connector 560.

Optionally, water trap portion 530 can further comprise a bottom opening 570 at the bottom of water trap portion 530, and a bottom cap 572 removably connected to bottom opening 570. Water trap portion 530 can be cleaned through bottom opening 570.

In the use, condensate water accumulates in water trap portion 530. Since lower side 563 of outlet tubular connector 560 is higher than the bottom edge of internal divider 534, the water and the internal divider 534 form a barrier between the condensate drain tray and downstream drainage pipe. Consequently, the odor in the downstream drainage pipe can not enter the house through the air handler of the air conditioner.

Alternatively, water trap portion can also be a substantially U-shape pipe, with the upper end of the right side of the U-shape structure integrally connected to lower end 524 of hollow tube portion 520, and the left side of the U-shape structure further extending into an outlet tubular connector which is in perpendicular to hollow tube portion 520.

Furthermore, water trap portion 530 can also function as a chemical delivery means. Either liquid or solid growth inhibiting chemicals can be added into water trap portion through open upper end 522 of hollow tube portion 520, which releases into the downstream drainage pipe to control microbial growth.

Optionally, condensate drain tray connector 500 can further include a basket 590. Basket 590 can have the same structure of basket 60 described previously. When basket 590 is used, connector body 510 can further include alignment means at upper end 522 of hollow tube portion 520 for aligning basket 590. The alignment means has been described previously in condensate drain tray connector 1.

Connector body, top, bottom and spout caps, and basket are preferably injection molded of a plastic material, such as polyethylene, polyvinyl chloride (PVC), and polyamide.

The invention has been described with reference to particularly preferred embodiments. It will be appreciated, however, that various changes can be made without departing from the spirit of the invention, and such changes are intended to fall within the scope of the appended claims. While the present invention has been described in detail and pictorially shown in the accompanying drawings, these should not be construed as limitations on the scope of the present invention, but rather as an exemplification of preferred embodiments thereof. It will be apparent, however, that various modifications and changes can be made within the spirit and the scope of this invention as described in the above specification and defined in the appended claims and their legal equivalents. All patents and other publications cited herein are expressly incorporated by reference.

I claim:

1. A condensate drain tray connector comprising:
(a) a connector body comprising:
an elongated hollow tube having an open upper end and an opposing open lower end for connecting to a downstream condensate drainage pipe;
an inlet tubular connector having a first end connected perpendicularly to said hollow tube and being in fluid communication with said hollow tube, and an opposing second end for connecting to a condensate drain tray; and
a cleaning spout including one end connected perpendicularly to said hollow tube and disposed opposing said inlet tubular connector, and an opposing spout opening covered by a removable spout cap;
(b) a basket removably disposed within said hollow tube of said connector body for receiving a growth inhibiting chemical; and
(c) a top cap removably connected to said open upper end of said hollow tube of said connector body.

2. The condensate drain tray connector of claim 1, wherein said basket has a pair of access openings positioned opposite each other; said access openings are aligned with said inlet tubular connector and said spout opening of said connector body.

3. The condensate drain tray connector of claim 2, wherein said upper opening of said hollow tube and an upper end of said basket have complementary alignment means for aligning said access openings of said basket with said inlet tubular connector and said spout opening of said connector body.

4. A condensate drain tray connector comprising:
a connector body comprising an elongated hollow tube having an open upper end and an opposing open lower end for connecting to a downstream condensate drainage pipe; and an inlet tubular connector connected perpendicularly to said hollow tube, and being in fluid communication with said hollow tube;
a top cap comprising a top cover portion, and a fastening portion extending downwardly from said top cover portion, said top cap being removably connected to said open upper end of said hollow tube of said connector body; and
a liquid level senor including a sensing portion disposed within said connector body and an external linkage portion extending outside of said connector body; said liquid level senor being removably connected to said connector body.

5. The condensate drain tray connector of claim 4, wherein said external linkage portion of said liquid level sensor connects said condensate drain tray connector to a control system.

6. The condensate drain tray connector of claim 4, wherein said inlet tubular connector has a receiving opening on an upper side of said inlet tubular connector between a first end and a second end of said inlet tubular connector, and said receiving opening has an internal thread.

7. The condensate drain tray connector of claim 6, wherein said liquid level sensor includes an adaptor portion connected between said sensing portion and said external linkage portion; said adaptor portion having an external thread complementary to said internal thread of said receiving opening of said inlet tubular connector; and said liquid level sensor is removably thread-connected to said receiving opening of said inlet tubular connector; wherein said sensing portion of said liquid level sensor is disposed inside said inlet tubular connector between said first and second ends of said inlet tubular connector.

8. The condensate drain tray connector of claim 4, wherein said liquid level sensor is attached to said top cover portion of said top cap; said sensing portion of said liquid level senor includes a sensor head and an extender portion that connects said sensor head to said top cap; and said sensing portion extends downwardly from said top cap and is disposed inside said hollow tube of said connector body.

9. The condensate drain tray connector of claim 8, wherein said sensor head of said liquid level sensor is disposed below said inlet tubular connector of said connector body.

10. The condensate drain tray connector of claim 4, wherein said connector body further comprises a cleaning spout including one end connected perpendicularly to said hollow tube and disposed opposing said inlet tubular connector, and an opposing spout opening covered by a removable spout cap.

11. A removable liquid level sensor cap assembly comprising:
(a) a cap comprising a circular top cover portion; and a fastening portion extending downwardly from said top cover portion; said fastening portion having connection means in an interior thereof for connecting to a tubular conduit; and
(b) a liquid level sensor attached to said top cover portion of said cap; said liquid level sensor comprising a sensing portion extending downwardly from said top cover portion, and an external linkage portion extending upwardly from said top cover portion.

12. The removable liquid level sensor cap of claim 11, wherein said sensing portion of said liquid level senor including a sensor head and an extender portion connecting said sensor head to said top cover portion of said removable liquid level sensor cap; and said sensor head is connected electronically to said external linkage portion through said extender portion.

13. The removable liquid level sensor cap of claim 11, wherein said external linkage portion connects said removable liquid level sensor cap to a control system.

14. The removable liquid level sensor cap of claim 11, wherein said sensor head is a float sensor.

15. A condensate drain tray connector comprising:
(a) a connector body comprising:
an elongated hollow tube portion having an open upper end, and an opposing lower end integrally connected to a water trap portion, with one side of said lower end extending into an external wall of said water trap portion, and with an opposing side of said lower end forming an internal divider within said water trap portion; said water trap portion including an outlet tubular connector for connecting to a downstream condensate drainage pipe, said outlet tubular connector being perpendicularly to said hollow tube portion and being disposed on a same side of said internal divider; and
an inlet tubular connector connected perpendicularly to said hollow tube portion on an opposing side of said outlet tubular connector, and being in fluid communication with said hollow tube; and
(b) a top cap removably connected to said open upper end of said hollow tube of said connector body.

16. The condensate drain tray connector of claim 15, wherein said water trap portion further comprises a bottom opening at a bottom of said water trap portion, and a bottom cap removably connected to said bottom opening.

17. The condensate drain tray connector of claim 15, wherein said connector body further comprises a cleaning spout including one end connected perpendicularly to said hollow tube portion and disposed opposing said inlet tubular connector, and an opposing spout opening covered by a removable spout cap.

18. The condensate drain tray connector of claim 15, where said top cap further comprises a liquid level sensor attached to said top cap; said liquid level sensor comprises a sensing portion extending downwardly from said top cap, and an external linkage portion extending upwardly from said top cap.

19. The condensate drain tray connector of claim 18, wherein said sensing portion of said liquid level senor includes a sensor head and an extender portion connecting said sensor head to said top cap; and said sensor head extends below said inlet tubular connector of said connector body.

20. The condensate drain tray connector of claim 18 further comprising a basket disposed within said hollow tube portion for receiving a growth inhibiting chemical.
